(19) United States
(12) Patent Application Publication
(10) Pub. No.: US 2016/0341362 A1
(43) Pub. Date: Nov. 24, 2016

(54) THERMAL PROTECTION SYSTEM FOR A CRYOGENIC TANK OF A SPACE VEHICLE

(71) Applicant: SNECMA, Paris (FR)

(72) Inventors: Didier VUILLAMY, Quincampoix (FR); Nicolas RAVIER, Vermon (FR); David HAYOUN, Paris (FR)

(73) Assignee: SNECMA, Paris (FR)

(21) Appl. No.: 15/111,989

(22) PCT Filed: Dec. 31, 2014
(86) PCT No.: PCT/FR14/53583

§ 371 Date: Jul. 15, 2016

(30) Foreign Application Priority Data
Jan. 15, 2014 (FR) 1450318

(51) Int. Cl. F17C 13/00

(52) U.S. Cl. CPC F17C 13/001; F17C 2205/0115; F17C 2221/08; F17C 2227/0341; F17C 2227/0386; F17C 2260/031; F17C 2270/0197

(57) ABSTRACT

An assembly including a cryogenic fluid tank for a space vehicle and a thermal protection system for a cryogenic fluid tank of the space vehicle, the system including: a shell adapted to surround the cryogenic fluid tank, the shell being dimensioned to define an inside space between the shell and the tank; and an injector for injecting a cooling fluid spray into the inside space; the cooling fluid being injected into the inside space in the liquid state at a temperature that is adapted to ensure that the cooling fluid picks up the heat flux reaching the cryogenic fluid tank, thereby causing the cooling fluid to vaporize, the shell having a plurality of orifices adapted to allow the cooling fluid in gaseous form to leave inside space through the shell.

### GENERAL TECHNICAL FIELD

The present invention relates to the field of cryogenic fluid tanks for a space vehicle, and it relates more particularly to means for thermally protecting such a tank.

### STATE OF THE ART

Space launchers that use cryogenic propellants present major problems associated with the nature of such propellants, which have a short lifetime during a stage of waiting for launch.

As a result of exchanging heat with the outside environment, cryogenic propellants are subjected to an increase of temperature in the tanks, thereby causing the propellants to change phase by passing into the gaseous phase, thus leading to a major rise in pressure inside the tanks, which pressure can reach levels that are too high.

The present solution consists in discharging gas from the tanks in order to limit the rise in pressure. Nevertheless, that leads to a loss of propellant, which therefore needs to be compensated just a few minutes before launch, and that is constraining in terms of preparations.

Furthermore, if a launch is postponed, propellant losses can be very great, requiring major refilling of the tanks. Depending on the length of time for which launch is postponed, it can even be necessary to empty the tanks completely and then fill them once more prior to launch.

There is therefore a need for a cryogenic propellant tank that is stable, enabling a cryogenic propellant to be maintained thermally over a duration that may be longer than a day.

### PRESENTATION OF THE INVENTION

To this end, the present invention provides an assembly comprising a cryogenic fluid tank for a space vehicle and a thermal protection system for a cryogenic fluid tank of the space vehicle, said system comprising:
a shell adapted to surround the cryogenic fluid tank, the shell being dimensioned to define an inside space between the shell and the tank; and
an injection duct (35) connected to a tank of cooling fluid (36) and adapted to inject a spray of cooling fluid into said inside space;
   the assembly being characterized in that said cooling fluid is injected into the inside space in the liquid state and at a temperature that is adapted to ensure that the cooling fluid picks up a heat flux reaching the cryogenic fluid tank, thereby causing said cooling fluid to vaporize, the shell having a plurality of orifices adapted to allow the cooling fluid in gaseous form to leave said inside space through the shell.

The assembly advantageously presents one or more of the following characteristics taken independently or in combination:
the system further includes injector means for injecting dry gas into the inside space;
the shell comprises a plurality of hinged segments adapted to be capable selectively of surrounding the cryogenic fluid tank and of releasing it prior to launch of the space vehicle; and
the shell has an inner wall and an outer wall with thermally insulating material being arranged between them.

The invention also provides a method of thermally protecting a cryogenic fluid tank of a space vehicle, comprising the following steps:
surrounding the tank with a shell so as to form an inside space between the shell and the tank;
injecting a spray of cooling fluid into the inside space as formed in this way, the cooling fluid being injected in liquid form at a temperature adapted so that the cooling fluid is vaporized as a result of exchanging heat with a heat flux reaching the tank; and
discharging the cooling fluid vapor formed by heat exchange with the tank through the shell via a plurality of orifices formed in the shell.

In a particular implementation, prior to injecting the spray of cooling fluid in the liquid state into the inside space, a dry gas is injected into said inside space in such a manner as to eliminate moisture from said inside space, and to avoid forming water ice or carbon dioxide ice, which might plug the passages allowing cooling fluid vapor to pass through the shell.

Optionally, prior to launching the space vehicle, and after injecting the cooling fluid into the inside space, a dry gas at ambient temperature is injected into the inside space in such a manner as to raise the surface temperature of the tank and avoid forming ice.

### SUMMARY OF THE FIGURES

Other characteristics, objects, and advantages of the invention appear from the following description, which is purely illustrative and non-limiting, and which should be read with reference to the accompanying drawings, in which:

FIG. 1 is a diagram of a space vehicle having a system in an aspect of the invention;

FIG. 2 is a detailed section view of the system in an aspect of the invention; and

FIG. 3 is a diagram showing a method in an aspect of the invention.

In the figures, elements that are common are identified by identical numerical references.

### DETAILED DESCRIPTION

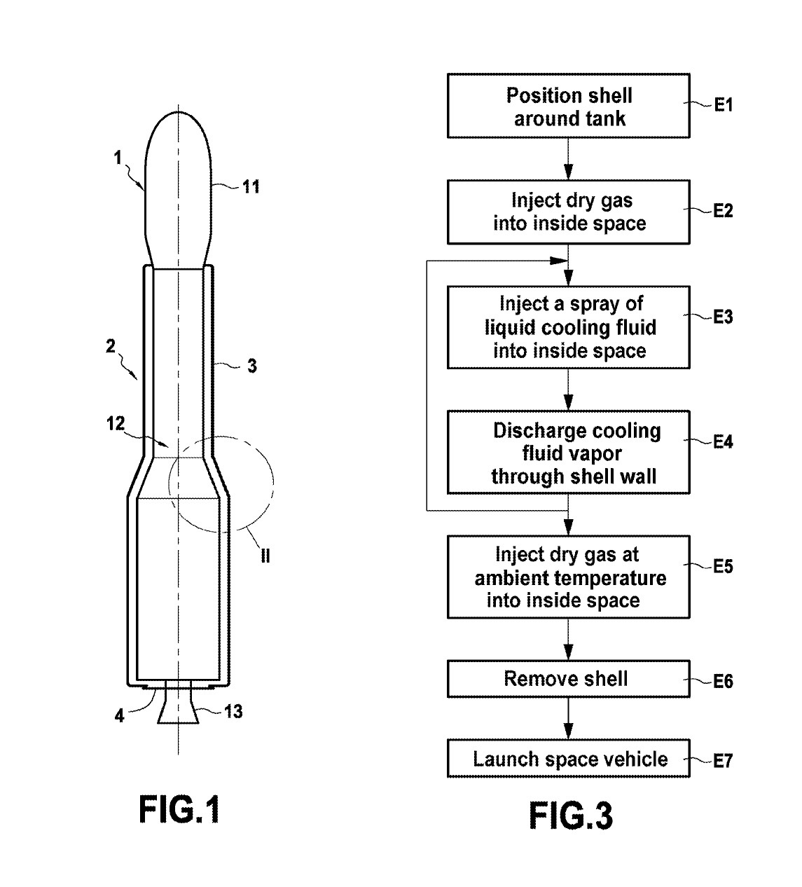

FIG. 1 is a diagram of a space vehicle having a system in accordance with an aspect of the invention.

This figure is a diagram showing a space vehicle 1, specifically a launcher having a nosecone 11, a propulsion stage 12, and a thruster 13.

The term “propulsion stage” 12 is used to designate broadly the stages of the space vehicle made up of equipment and cryogenic tanks.

The propulsion stage 12 is thus shown as being surrounded by a thermal protection system 2, comprising a shell 3 that surrounds the cryogenic fluid tanks included in the propulsion stage, and a base 4 providing sealing at the level of the thruster 13.

The shell 3 thus advantageously covers all of the cryogenic tanks of the space vehicle.

The shell 3 is adapted to perform a function of thermally protecting the cryogenic tanks of the space vehicle, and more precisely of avoiding any rise in temperature and pressure within the cryogenic tanks of the space vehicle while these cryogenic tanks contain cryogenic fluid.

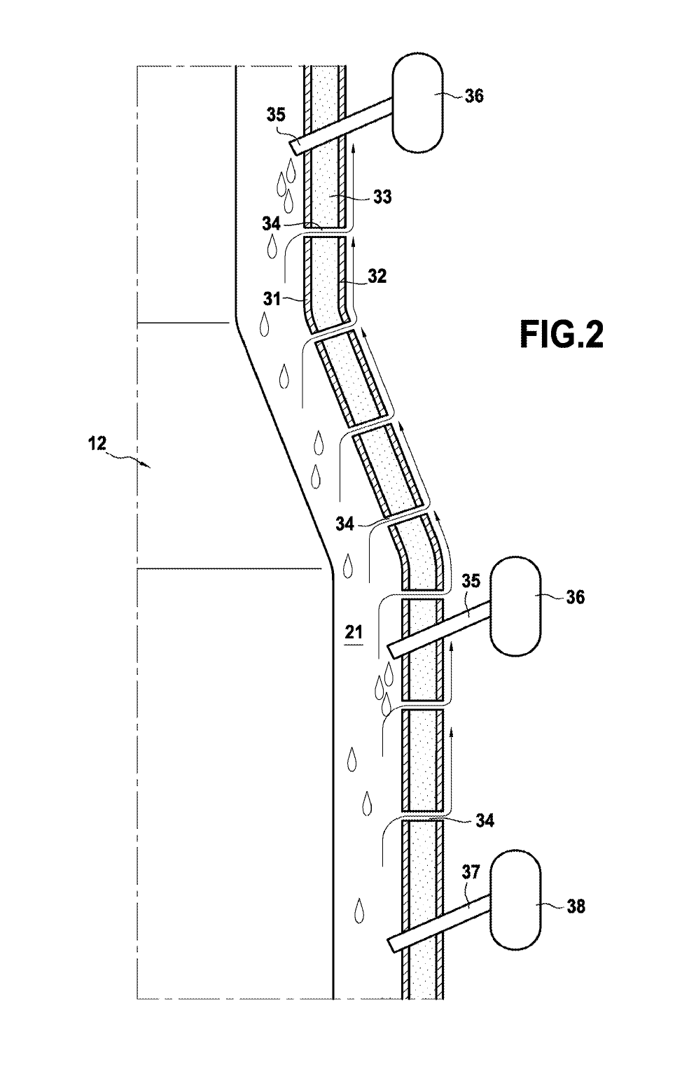

With reference to FIG. 2, there follows a description of an example of structure for the shell 3 in accordance with an aspect of the invention.

The shell 3 as shown comprises an inner wall 31 and an outer wall 32 containing between them a partition 33 made of thermally insulating material.

By way of example, the inner wall 31 and the outer wall 32 are made of metal, while the partition 33 is made of polyurethane foam, for example.

The shell 3 typically has a thickness of the order of 10 centimeters (cm) to 20 cm.

The weight of the shell is thus advantageously kept to a value that is as low as possible, in order to facilitate putting it into place and removing it.

The shell 3 is typically formed by a plurality of hinged-together segments, so as to be capable of being assembled together in order to surround a space vehicle 1, and also of being separated in order to enable the shell 3 to be withdrawn, thereby releasing the space vehicle 1, e.g. in order to allow it to be launched.

When the shell 3 is arranged around the space vehicle 1, it defines an inside space 21 between the outside surface of the space vehicle 1 and the shell 3.

The shell 3 may thus have supports adapted to come into contact with the space vehicle 1 and ensure predefined spacing between the space vehicle 1 and the shell 3. These supports are advantageously made of flexible material in order to avoid damaging the walls of the space vehicle 1.

The system 2 also has injector means for injecting a spray of cooling fluid in liquid form into the inside space 21 defined between the shell 3 and the tank, e.g. in the form of a spray of droplets or microdroplets.

In the embodiment shown, the injector means comprise an injection duct 35 connected to a cooling fluid tank 36.

A plurality of injector means 35 and 36 are distributed at various points of the shell 3 so as to obtain a substantially uniform distribution of cooling fluid spray in the inside space 21.

By way of example, the cooling fluid is dinitrogen (N₂), which is compatible with the temperature of the propellants contained in the cryogenic tanks of spacecraft, and advantageous in terms of price and availability.

By way of example, the cooling fluid is injected in liquid form, at a temperature lower than the temperature that the wall of the cryogenic fluid tank of the space vehicle would have in the absence of the assembly as described. More generally, and as explained below, the cooling fluid is injected at a temperature that is low enough to enable it to pick up all or at least some of the heat flux reaching the cryogenic fluid tank.

The system 2 also has means for injecting dry gas into the inside space 21.

The term “dry gas” is used herein to mean a gas that does not contain gaseous substances that will liquefy while it is in use.

In the embodiment shown, these dry gas injector means comprise injection nozzles 37 fed by a dry gas tank 38. A plurality of dry gas injector means 37, 38 may be distributed at various points of the shell 3, likewise in such a manner as to enable dry gas to diffuse in substantially uniform manner in the inside space 21 between the shell 3 and the tank.

The shell 3 is adapted to allow gas to pass from the inside space 21 to the outside by passing through the shell 3. This function may be performed in several different ways; mention may be made in particular of using permeable materials for making all or part of the shell 3. In the embodiment shown in FIG. 2, the shell 3 includes orifices 34 distributed at various points of the shell 3, thus enabling the gas that is to be found in the inside space 21 to escape to the outside of the shell 3 by passing through the shell 3 via these orifices 34.

The size of the orifices 34 is typically of millimeter order. Having a multiplicity of orifices enables the escaping gas stream to be well regulated and limits the impact on exhausting the gas of dispersion in their sizes.

The shell 3 is dimensioned so as to surround at least the cryogenic tanks of the space vehicle 1.

When the cryogenic tank contains oxygen or methane, the cooling fluid may for example be liquid nitrogen.

There follows a description of an example of the operation of the above-described system 2, with reference to above-described FIG. 2 and with reference to FIG. 3 which is a diagram representing a method in an aspect of the invention.

The system 2 is positioned around the cryogenic tank of the space vehicle during a positioning step El. With the cryogenic tank previously filled or being filled, the shell 3 and the various injector means 35, 36, 37, and 38 are put into position around the tank.

Thereafter, an optional step E2 of injecting dry gas into the inside space 21 via the dry gas injector means 37 and 38 is performed. This optional step serves to evacuate moisture from the inside space 21 and avoids or at least greatly reduces any risk of ice appearing on the outside wall of the space vehicle 1. The injected dry gas is discharged through the shell 3, e.g. via the above-described orifices 34.

The temperature of the injected dry gas is then progressively lowered, until its temperature is of the same order as its temperature in the liquid state, thus making it possible to avoid or at least greatly limit any risk of admitting air into the inside space 21 during step E3 as described below.

Thereafter, a step E3 is performed of injecting a spray of cooling fluid in liquid form into the inside space 21 via the injector means 35 and 36. The cooling fluid in liquid form is injected at a temperature that is adapted as a function of the temperature of the cryogenic tank, and in particular of the content of the cryogenic tank. In this way, the cooling fluid intercepts any heat reaching the cryogenic tank, thereby preventing it from heating. The heat picked up by the cooling fluid causes it to vaporize; it thus passes into gaseous form and is discharged from the inside space 21 through the shell 3 in a step given reference E4.

Although steps E3 and E4 are shown as being distinct steps, they take place simultaneously while the thermal protection system 2 is in operation. The injection of cooling fluid into the inside space 21 is performed continuously so as to ensure that the tank is maintained at a given temperature, thereby causing vapor of the cooling fluid to be generated continuously and to be discharged continuously through the shell 3.

This discharge of cooling fluid vapor through the shell 3 is advantageously made easier by applying a pressure in the inside space 21 that is higher than the pressure of the surrounding medium, thereby also making it possible to avoid outside air at ambient temperature penetrating into the inside volume 21. By way of example, such higher pressure may be obtained by adjusting the dimensions of the orifices 34 formed through the shell 3.

Furthermore, the cooling fluid vapor flows along the inner wall 31 and along the outer wall 32 of the shell 3, as represented diagrammatically by arrows in FIG. 2, thus making it possible both to limit exchanges of heat from the outside medium to the inside space 21, and also to limit the formation of ice on the outer 32 of the shell 3 by maintaining a continuous stream of cooling fluid vapor over the outer wall 32.

When launch of the space vehicle is imminent, cooling fluid ceases to be injected E5, and dry gas, typically at ambient temperature, is injected once more into the inside space 21, momentarily raising the outside temperature of the launcher to a temperature closer to the temperature at which ice forms.

The shell 3, and more generally the system 2, is then removed from the space vehicle 1 during a step E6, prior to the space vehicle 1 being launched E7.

The proposed system 2 thus presents several advantages.

Firstly, it provides active thermal protection, maintaining the cryogenic tanks of a space vehicle at a desired temperature, and thus serving to avoid any need for degassing and possibly even draining followed by refilling in the event of launch being postponed.

By way of example, for a dihydrogen cryogenic tank having a volume of 16 cubic meters, i.e. dimensions of 6 meters (m) in height and 2 m in diameter, and presenting conventional structural insulation, the heat flux that enters in the absence of a thermal protection system of the kind described is estimated at 8 kilowatts (kW). The proposed system makes it possible to reduce the incoming heat flux to less than 400 watts (W), thereby making it possible to reduce losses of dihydrogen quite considerably, and enabling pressure within the tank to rise very slowly, thus making it possible to accommodate waiting times that may be as long as several days.

By way of comparison, giving consideration to a hermetically closed 7 cubic meter dihydrogen cryogenic tank, in the absence of any thermal protection system as described, after waiting for one hour, the pressure within the tank is about 2.1 bars, corresponding to the pressure of the single-phase state.

By using a system as described, on the same tank, the pressure in the tank reaches 1.6 bars after waiting 12 hours.

The consumption of cooling fluid is also relatively low; in the example described, the requirement for dinitrogen is 2 grams (g) per second.

The system 2 may also be coupled to means for filling cryogenic tanks, thus making it possible to reduce the time constraints that are imposed when filling cryogenic tanks.

Furthermore, the proposed system prevents ice forming at the surface of the space vehicle 1, and it is constituted solely by components that are external to the space vehicle 1 and that therefore do not require any structural modifications to the space vehicle 1.

1. An assembly comprising a cryogenic fluid tank for a space vehicle and a thermal protection system for the cryogenic fluid tank of the space vehicle, said system comprising:
a shell adapted to surround the cryogenic fluid tank, the shell being dimensioned to define an inside space between the shell and the tank; and
an injection duct connected to a tank of cooling fluid and adapted to inject a spray of cooling fluid into said inside space;
wherein said cooling fluid is injected into the inside space in the liquid state at a temperature that is adapted to ensure that the cooling fluid picks up a heat flux reaching the cryogenic fluid tank, thereby causing said cooling fluid to vaporize, the shell having a plurality of orifices adapted to allow the cooling fluid in gaseous form to leave said inside space through the shell.

2. The assembly according to claim 1, wherein said system further comprises an injector means for injecting dry gas into the inside space.

3. The assembly according to claim 1, wherein said shell comprises a plurality of hinged segments adapted to be capable selectively of surrounding the cryogenic fluid tank and of releasing it prior to launch of the space vehicle.

4. The assembly according to claim 1, wherein said shell has an inner wall and an outer wall with thermally insulating material being arranged between them.

5. A method of thermally protecting a cryogenic fluid tank of a space vehicle, comprising the following steps:
surrounding the tank with a shell so as to form an inside space between the shell and the tank;
injecting a spray of cooling fluid into the inside space as formed in this way, the cooling fluid being injected in liquid form at a temperature adapted so that the cooling fluid is vaporized as a result of exchanging heat with a heat flux reaching the tank; and
discharging the cooling fluid vapor formed by heat exchange through a plurality of orifices in the shell.

6. The method according to claim 5, wherein, prior to injecting the spray of cooling fluid in the liquid state into the inside space, a dry gas is injected into said inside space in such a manner as to eliminate moisture from said inside space.

7. The method according to claim 5, wherein, prior to launching the space vehicle, and after injecting the cooling fluid into the inside space, a dry gas at ambient temperature is injected into the inside space in such a manner as to eliminate moisture from said inside space.
